(19) United States
(12) Patent Application Publication
(10) Pub. No.: US 2010/0064829 A1
(43) Pub. Date: Mar. 18, 2010

(54) HIGH PRECISION POSITIONING APPARATUS HAVING A ROTATING DRIVING ELEMENT AND A ROTATING DRIVEN ELEMENT

(75) Inventor: James Lawrence Dale, Arden, NC (US)

Correspondence Address: DAVID M. CARTER;CARTER & SCHNEDLER, P.A., P.O. BOX 2985, ASHEVILLE, NC, 28802, US

(73) Assignee: AvL Technologies, Inc., Asheville, NC (US)

(21) Appl. No.: 12/557,579

(22) Filed: Sep. 11, 2009

Related U.S. Application Data
(60) Provisional application No. 61/192,405, filed on Sep. 17, 2008.

(51) Int. Cl. F16H 19/00; F16H 7/02

(52) U.S. Cl. 74/89.22

(57) ABSTRACT

There is provided a rotary positioning apparatus including a driven element and a driving element, each of which has a curved outer surface. A cable connects the driven element to the driving element. The cable is wound a plurality of times about a portion of the outer surfaces of the driving element and the driven element for applying rotational forces from the driving element to the driven element. The outer surface of at least one of the driving element or the driven element having a plurality of V-shaped grooves therein. Portions of the cable are wedged in portions of the grooves thereby substantially reducing slippage of the cable.

### RELATIONSHIP TO PRIOR APPLICATION

This is a U.S. non-provisional application relating to and claiming the benefit of U.S. Provisional Patent Application Ser. No. 61/192,405, filed Sep. 17, 2008.

### BACKGROUND OF THE INVENTION

This invention relates to a positioning apparatus and in particular to a positioning apparatus in which a driving element is rotatably connected to a driven element by a cable for positioning the driven element. For various apparatus such as parabolic reflectors for satellite antennas there is a need to position such apparatus very precisely. Mechanical positioning systems have been provided which utilize a driving element which is connected to an electric motor through a gearing system or through a mechanical linkage such as a belt. A driven element which is directly connected to the apparatus which needs to be precisely positioned, such as a satellite antenna, is also provided. Normally, the driving element is connected to the driven element by cables. Such cable systems are described in U.S. Pat. Nos. 5,105,672 and 4,351,197, both issued to Carson. While the apparatii disclosed in the Carson patents provide a certain degree of precise positioning, there is a need for more stiffness and capacity for many applications, in particular for satellite antenna applications.

### BRIEF SUMMARY OF THE INVENTION

In accordance with one form of this invention, there is provided a positioning apparatus having a driven element and a driving element. The driven element includes a drum having an outer surface. The drum is adapted to rotate. The driving element also has an outer surface. At least one cable connects the driving element to the drum. The outer surface of at least one of the driving element or the driven element has a plurality of grooves therein. The grooves have two opposing side walls, a bottom, and an open top. The side walls slope inwardly from the open top to the bottom. A portion of the cable is received in the grooves and is wedged between the side walls.

In accordance with another form of this invention, there is provided a rotary positioning apparatus including a driven element and a driving element each of which having a curved outer surface. At least one cable connects the driven element to the driving element. A portion of the cable is wound a plurality of times about a portion of the outer surfaces of the driving element and the driven element for applying rotational forces from the driving element to the driven element. The outer surface of at least one of the driving element or the driven element has a plurality of radial grooves therein. The radial grooves are somewhat V-shaped. Portions of the cable are wedged in portions of the grooves thereby substantially reducing slippage of the cable.

In the preferred embodiment, the outer surfaces of both the driving element and the driven element have the grooves. Also, in the preferred embodiment the wedging of the cable in the grooves causes an increase in the contact forces between the cable and the driving and/or driven element(s) thus increasing friction and reducing the likelihood that the cable will slip. Portions of the cable may become deformed or, flattened where the cable contacts the side walls of the grooves, due to this increased pressure.

### BRIEF DESCRIPTION OF THE DRAWINGS

FIG. 1 is a front perspective view of a satellite antenna including the parabolic reflector which requires precise positioning and utilizes driving elements and driven elements in accordance with this invention.

FIG. 2 is a rear elevational view of a portion of FIG. 1 which shows a pair of driving elements and a pair of corresponding driven elements.

FIG. 3 is a plan view showing a driving element and driven element in accordance with one embodiment of the invention.

FIG. 4 is a side elevational view of a portion of FIG. 3.

FIG. 5 is a simplified top view of the apparatus of FIG. 4.

FIG. 6 is a side elevational view of the driven element of FIG. 5 in simplified form.

FIG. 7 is a detailed sectional view of a portion of FIG. 6 taken through section line 7-7.

FIG. 8 is a cross-section of the cable, taken through section lines 8-8 of FIG. 4, which illustrates its round shape before it is inserted into a groove.

FIG. 9 is a sectional view of FIG. 4 taken through section line 9-9 and shows the deformed cable of FIG. 7 having been removed from the groove.

### DESCRIPTION OF THE PREFERRED EMBODIMENT

Referring now more particularly to FIG. 1, there is provided a satellite antenna system 10 including parabolic reflector 12 and transponder element 14 which is extended away from the surface of parabolic reflector 12. The satellite antenna system 10 includes a pair of driven elements,16 and 18, which are used to precisely position parabolic reflector 12. The driving elements, which will be discussed below, are not visible from the front side of the antenna system of FIG. 1. The antenna system 10 also includes a base 21 for stabilizing the system on the ground.

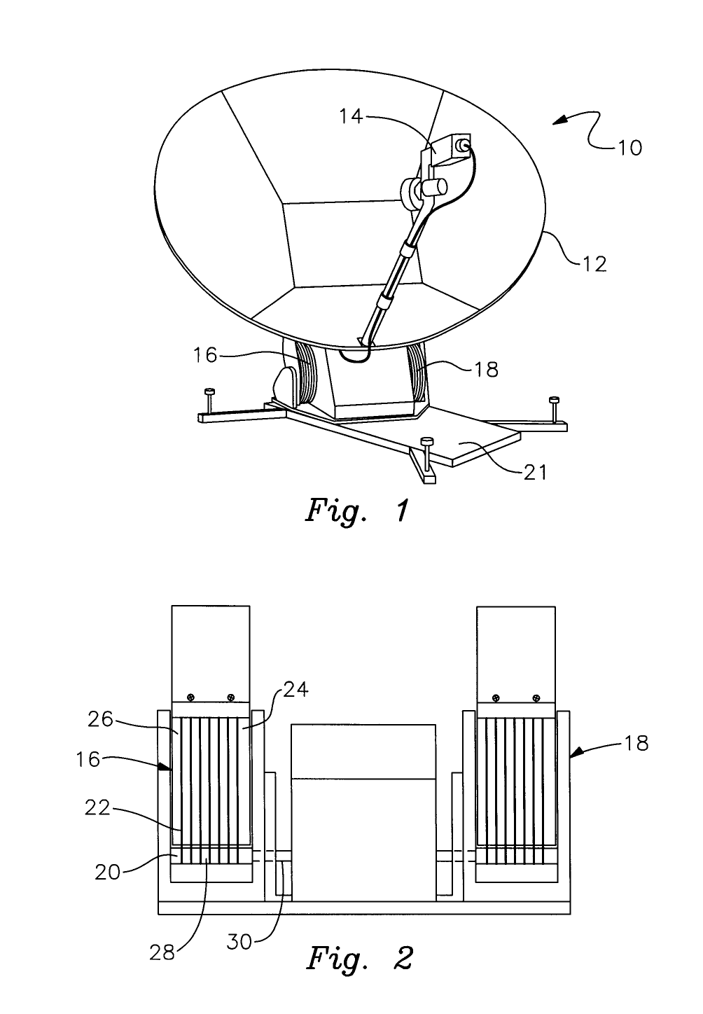

FIG. 2 shows a portion of the rear of the satellite system of FIG. 1. Driven element 16 is connected to driving element 20 by a plurality of cables 22 or multiple loops of a single cable. Driven element 16 includes a drum 24 having an outer surface 26. Driving element 20 also includes an outer surface 28. Driven element 18 and its corresponding drive element are identical to driven element 16 and driving element 20. The remaining description with respect to the driven element and driving element will therefore only be in reference to driven element 16 and driving element 20.

Portions of cable 22 are received in V-shaped grooves in the outer surface 26 of drum 24 and the outer surface 28 of driving element 20. As used herein, the term “V-shaped” means both in the shape of a V having a somewhat of a point at its apex, as well as a V shape with a bottom wall rather than a point at its apex which, in the preferred embodiment of this invention, is somewhat rounded to form a concave shape which is illustrated in FIG. 7.

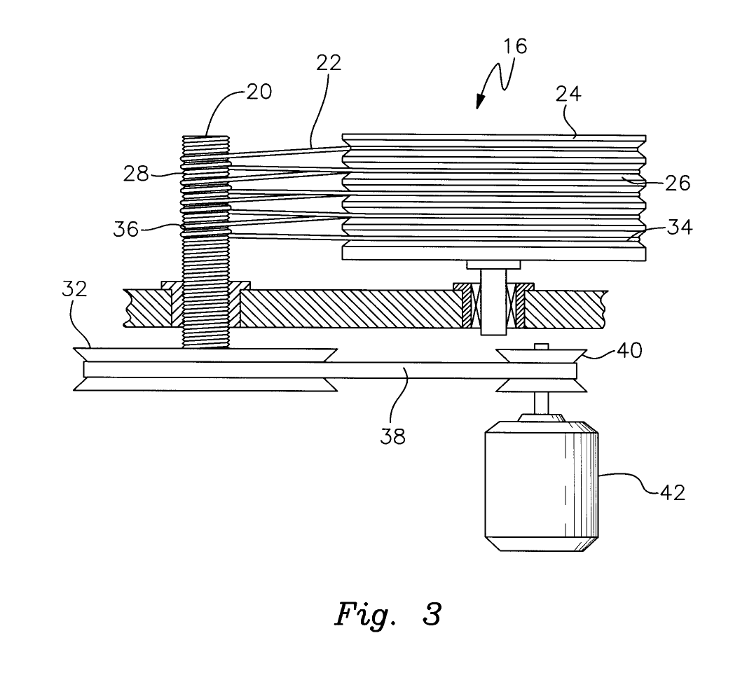

Driving element 20 may be connected to a drive shaft 30 as illustrated in FIG. 2, or drive wheel 32 as illustrated in FIG. 3.

Referring now more particularly to FIG. 3, the outer surface 26 of drum 24, which forms a portion of driven element 16, includes a plurality of V-shaped grooves 34. In addition, the outer surface 28 of driving element 20 also includes a plurality of V-shaped grooves 36. It is preferred that the V-shaped grooves 36 on the outer surface of the driving element are somewhat at an angle, i.e. similar to the threads on a screw.

In the embodiment of FIG. 3, driving element 20 is coupled to pulley 32. Drive belt 38 connects pulley 32 to pulley 40, which in turn is connected to electric motor 42.

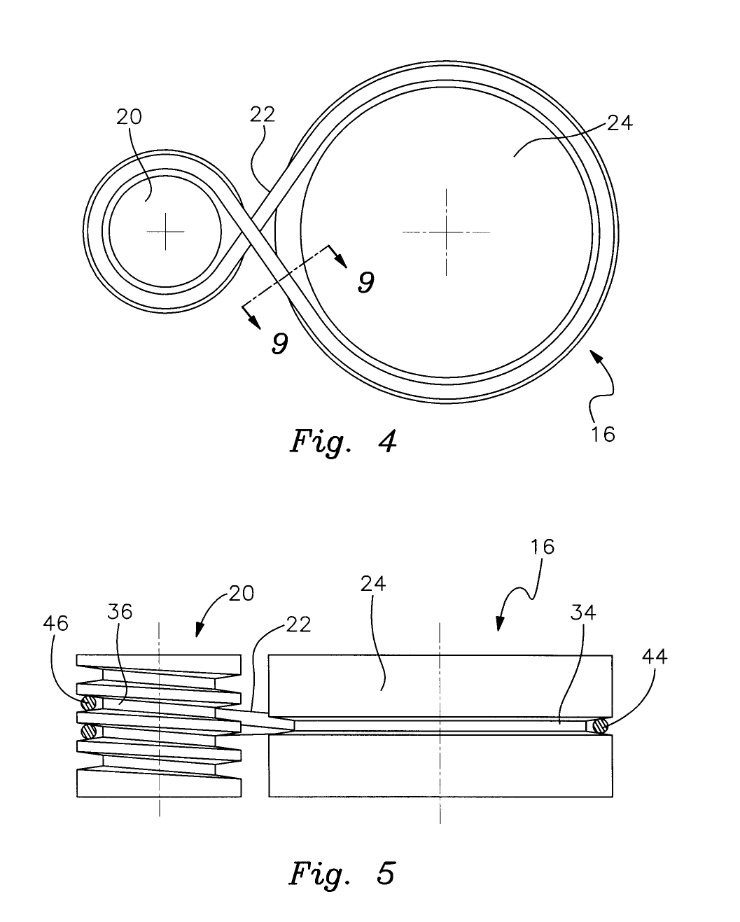

FIG. 4 shows cable 22 looped about drum 24 of driven element 16 and looped about driving element 20. Preferably cable 22 is made of steel.

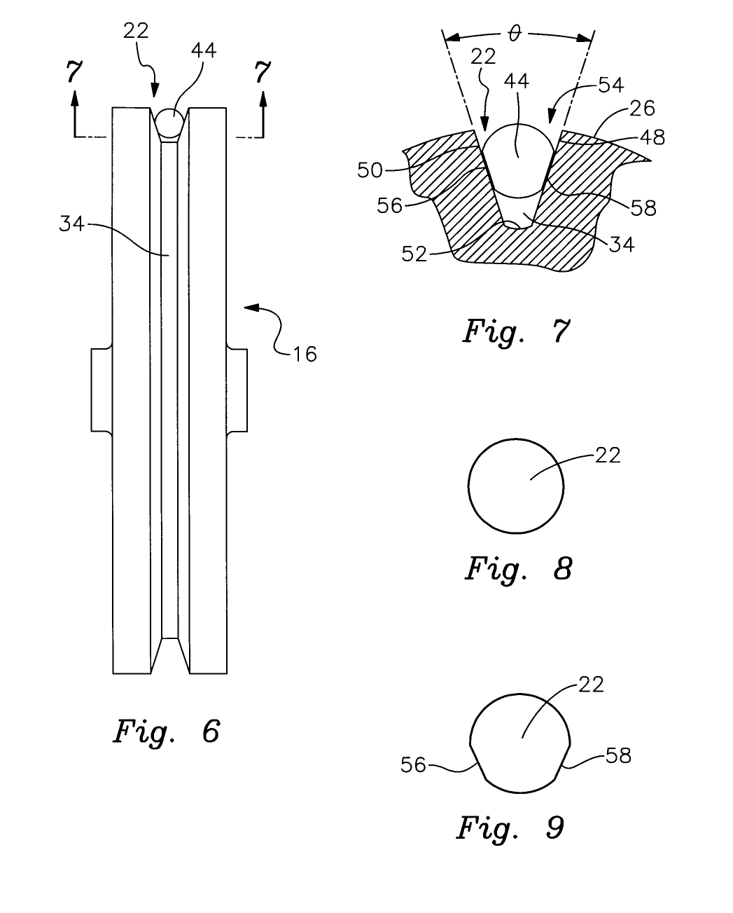

Referring now more particularly to FIG. 5, portion 44 of cable 22 is shown wedged in V groove 34 of driven element 16. In addition, portions 46 of cable 24 are shown wedged in groove 34 of driving element 20. The wedging of portion 44 of cable 22 in V groove 34 of driven element 16 is also illustrated in FIG. 6.

Referring now more particularly to FIG. 8, there is shown a cross-section of cable 22 before the cable is mounted on the driven and driving elements. In the preferred embodiment, cable 22 is round before it is installed on driven element 16 and driving element 20.

Referring now more particularly to FIG. 7, there is a more detailed view of a portion of the driven element 16 of FIG. 6. Portion 44 of cable 22 is shown wedged in V groove 34 which is in the outer surface 26 of drum 24 which forms a part of the driven element 16. V groove 34 includes opposing side walls 48 and 50 as well as bottom wall 52. The top of the groove 34 is open to receive cable 22. Side walls 48 and 50 project inwardly from the outer surface 26 to the bottom wall 52 so as to form the angle E between the side walls 48 and 50. Preferably the angle θ is between 32° and 40°. The opening 54 in groove 34, or major width, is greater than the diameter of cable 22 as illustrated in FIG. 8. However, part of the way into the groove, the distance between side walls 48 and 50 becomes less than the diameter of cable 22. The distance between side walls 48 and 50 at the bottom wall 52, or minor width, is substantially less than the diameter of cable 22. Thus cable 22 should not contact bottom wall 52. Since cable 22 is forced into groove 34 under substantial load, cable 22 becomes wedged between side walls 48 and 50. This wedging results in higher contact forces and higher pressure between the cable 22 and the drum 24 and/or the driving element 20 which reduces the likelihood that the cable 22 will slip thus increasing the positioning precision for the reflector 12. Portions of cable 22 may deform as illustrated by flattened portions 56 and 58 of cable 22. Flattening of cable 22 is illustrated both in FIG. 7 and FIG. 9.

The wedging of cable 22 within groove 34 also increases the friction between the walls 48 and 50 of groove 34 and cable 22. Thus, the contact forces are increased thereby enhancing the traction capacity of the interface between the cable and the groove. This in turn will improve the stiffness of the system by substantially eliminating the slipping between the cable and the driven element and, in addition, substantially reduces stretching of the cable. The angle θ between the walls 48 and 50 of the groove 34 should be such that the cable 22 will be wedged between the walls 48 and 50, and the cable does not contact bottom wall 52. Normal forces are increased as the cable wedges into each groove.

Stiffness of the system referred to is measured in general by the amount of load the cable can carry before it begins to slip. Initial tests show an increasing stiffness at higher torques in the V groove system described above over a non-grooved or flattened system such as the one described in U.S. Pat. No. 5,105,672 or a wide grooved system such as the one described in U.S. Pat. No. 4,351,197. Also, because of the improved friction between the cable and V grooves constructed as set forth above, a fewer number of wraps or loops, particularly about the driving element, are required. By reducing the slippage of the cable, positioning of the driven element and thus the entire satellite apparatus system which is attached to the driven element such as the satellite antenna reflector, is made more precise. While the V grooves have been specifically discussed in reference to the driven element 16, preferably the identical V grooves are used in the driving element 18, and thus the detailed description of such V groove in the driving element need not be repeated.

While the invention has been described in terms of the above embodiments, those skilled in the art will recognize that the invention can be practiced with modification within the spirit and scope of the appended claims.

What is claimed is:

1. A positioning apparatus comprising:
a driven element including a drum;
the drum having an outer surface;
the drum adapted to rotate;
a driving element;
the driving element having an outer surface;
at least one cable connecting the drive element to the drum;
the outer surface of at least one of the drive element or the drum having a plurality of grooves therein;
the grooves having two opposing side walls, a bottom and an open top;
the side walls sloping inwardly from the open top to the bottom; and
a portion of the cable received in the grooves and being wedged between the side walls.

2. An apparatus as set forth in claim 1 wherein the bottom of the grooves includes a bottom wall.

3. An apparatus as set forth in claim 2 wherein the cross-sections of the grooves are substantially V-shaped.

4. An apparatus as set forth in claim 2 wherein the cable does not contact the bottom wall.

5. An apparatus as set forth in claim 1 wherein the force between the cable and the side walls cause the cable to be deformed where the cable contacts the side walls.

6. An apparatus as set forth in claim 5 wherein the pressure between the cable and side walls is increased, thereby increasing the contact forces and enhancing the traction between the cable and the drum and/or the driving element.

7. An apparatus as set forth in claim 1 wherein the angle between the side walls is approximately between 32° and 40°.

8. An apparatus as set forth in claim 1 wherein both the surface of the drum and the surface of the driving element have grooves therein.

9. An apparatus as set forth in claim 1 further including a plurality of cables; the cables being looped about the drum and the driving element a plurality of times.

10. An apparatus as set forth in claim 1 wherein the cable is made of metal.

11. A rotary positioning apparatus comprising:
a driven element having a curved outer surface;
a driving element having a curved outer surface;
at least one cable connecting the driven element and the driving element;
a portion of the cable being wound a plurality of times about a portion of the outer surface of the driving element and the driven element for applying rotational forces from the driving element to the driven element;
the outer surface of at least one of the driving element or the driven element having a plurality of radial grooves therein;
the grooves being somewhat V-shaped; and
portions of the cable being wedged in portions of the grooves thereby substantially reducing slippage of the cable.

12. An apparatus as set forth in claim 11 wherein the grooves have inwardly sloping side walls and a bottom wall; the cable wedged between the side walls.

13. An apparatus as set forth in claim 11 wherein the cross-sections of the grooves are substantially V-shaped.

14. An apparatus as set forth in claim 12 wherein the cable does not contact the bottom wall.

15. An apparatus as set forth in claim 11 wherein the force between the cable and the side walls cause the cable to be deformed where the cable contacts the side walls.

16. An apparatus as set forth in claim 15 wherein the pressure between the cable and the side walls is increased thereby increasing contact forces and enhancing the traction between the cable and the driving and/or the driven elements.

17. An apparatus as set forth in claim 12 wherein the angle between the side walls is approximately between 32° and 40°.

18. An apparatus as set forth in claim 11 wherein both the outer surfaces of the driving element and the driven element have grooves therein.

19. An apparatus as set forth in claim 11 wherein the grooves have a major width and a minor width, the width of the cable being greater than the minor width but less than the major width.
